(19) United States
(12) Patent Application Publication
(10) Pub. No.: US 2018/0317025 A1
(43) Pub. Date: Nov. 1, 2018

(54) A SENSOR COMPRISING TWO PARALLEL ACOUSTICAL FILTER ELEMENTS, AN ASSEMBLY COMPRISING A SENSOR AND THE FILTER, A HEARABLE AND A METHOD

(71) Applicant: Sonion Nederland B.V., Hoofddorp (NL)

(72) Inventors: Benjamin Abraham Zeev Mimoun, Hoofddorp (NL); Michel de Nooij, Hoofddorp (NL)

(21) Appl. No.: 15/908,351

(22) Filed: Feb. 28, 2018

(30) Foreign Application Priority Data
Mar. 2, 2017 (EP) 17159020.1

(51) Int. Cl. H04R 25/00

(52) U.S. Cl. CPC H04R 25/453; H04R 25/65; H04R 25/505

(57) ABSTRACT

A sensor having a movable element, such as a microphone with a diaphragm, where received sound is filtered by two parallel acoustical filters before being sensed by the sensor, where one acoustical filter has a larger acoustical resistance and a lower acoustical mass than the other.

### CROSS-REFERENCE TO RELATED APPLICATIONS

This application claims the benefit of European Patent Application Serial No. 17159020.1, filed Mar. 2, 2017, which is incorporated herein by reference in its entirety.

### FIELD OF THE INVENTION

The present invention relates to a sensor with a parallel acoustical filter which reduces a sensitivity peak without adding as much noise as hitherto.

### BACKGROUND OF THE INVENTION

Acoustical filters and hearables may be seen in US20120177229, U.S. Pat. No. 9,380,377, U.S. Pat. No. 9,351,084, U.S. Pat. No. 8,879,767, EP 2 608 570, U.S. Pat. No. 9,185,498, EP2826258, WO2011001405, WO2016/102923, U.S. Pat. No. 2,865,464, US2004/084244, US2005/069164, US2008/157301, WO97/47117, DE1437371, and U.S. Pat. No. 8,184,845.

Acoustical peak damping is a known microphone designer issue. In order to avoid overload problems at the input of the hearing aids, HA manufacturers usually require a microphone response to be as flat as possible (compared to the microphone 1 kHz sensitivity value).

### SUMMARY OF INVENTION

For example, the current state of the art undamped 0-series Sonion microphone O11AC03 has a nominal peak height of 13 dB at 16 kHz related to its 1 kHz value (see FIG. 7). A peak height typically required by HA manufacturers is <5 dB re. 1 kHz.

There are several known way to reduce a microphone peak height, both in the acoustical and in the electrical domain, all having trade-offs.

As to acoustical damping, this is typically obtained using an acoustical resistance (usually in the form of a grid in the front volume of the microphone). A rule of thumb for the trade-off between peak damping and noise increase is that a 2 dB peak damping generates 1 dB noise increase. Noise increase due to acoustical damping is mainly seen in the high frequency range, but it already contributes significantly to noise increase in the mid-range frequencies (500 Hz-2 kHz). Thus, the trade-off in this context is that a significant peak reduction generates a significant SNR reduction.

The present invention relates to a manner obtaining acoustical damping but by adding less noise in the process.

In a first aspect, the invention relates to a sensor comprising:
a movable element,
a chamber being at least partly defined by the movable element,
a filter comprising a first and a second filter element, where
the first filter element has a first acoustical path with a first and a second opening, an acoustical resistance Ra1, and an acoustical mass Ma1,
the second filter element has a second acoustical path with a third and a fourth opening, an acoustical resistance Ra2, and an acoustical mass Ma2,
the first and third openings open into the chamber,
Ra2<Ra1 and Ma1<Ma2.

In the present context, a sensor is usually an element able to sense or detect a parameter and output a signal, usually an electrical signal, corresponding to the parameter, where “corresponding to” often means that the signal varies with any variation in the parameter. The signal may be a voltage/current output which varies in the same manner as the parameter, but other types of signals, such as digital signals and the like may instead vary by representing, over time, different values.

The movable element usually is movable by a sound pressure, such as sound, impinging on the movable element. Often, the movable element is called a diaphragm or membrane, as is typically used in microphones. It is noted that the present sensor is not limited to vibrations in the audible range. Any frequency or frequency interval may be used or sensed.

In a preferred embodiment, the movable element is flexible and able to flex and vibrate due to impinging air pressure variations, such as sound. Then, the sensor may comprise a signal generator capable of outputting a signal corresponding to the flexing of the movable element. In one embodiment, the movable element is a piezoelectric material itself outputting a signal due to its deformation. Other such signal generators may be based on any of the usual techniques, such as piezo electric materials, moving armature, balanced armature, moving coil, electret or the like.

An alternative to a diaphragm could be a tiltable/bendable element exposed to the vibrations and tilting/bending/vibration in response thereto.

The chamber is at least partly defined by the movable element. In usual microphones, the movable element would divide the inner space of a housing into two chambers, where one chamber would be called the front chamber and where sound would be able to enter the front chamber from the outside of the housing. Actually, sound may be allowed into both chambers in some microphones.

The chamber may be formed or defined by multiple elements, such as other acoustical channels attached to a housing of the sensor and/or other housings, such as a separate filter housing.

The chamber has the function of guiding an acoustical signal received from the first and second openings toward the movable element. The chamber may also act to prevent other acoustical signals from entering the chamber to impinge on the movable element—or to prevent the acoustical signals from the first/third openings from escaping the chamber.

In the present context, the filtered acoustical signal impinges on the one side of the movable element.

In principle, the other side of the movable element may take part in delimiting another chamber, as is seen in standard microphones.

The filter has two filter elements where the first filter element has a first acoustical path with a first and a second opening, an acoustical resistance Ra1, and an acoustical mass Ma1, and the second filter element has a second acoustical path with a third and a fourth opening, an acoustical resistance Rat, and an acoustical mass Mat.

The two filter elements may be embodied in any desired manner. As will be described below, the first and second filter elements act in parallel to individually filter an acoustical signal and feed it into the chamber (the first and third openings open into the chamber) to be able to impinge on the movable element. The filter elements may be provided individually as individual elements or may be provided as an assembly thereof, such as as a monolithic element. In one embodiment, the filter elements are formed in one element having two opposite sides where an acoustical signal is fed from one side to the other in parallel by the filter elements.

The filtering of the two filter elements is different, as Ra2<Ra1 and Ma1<Ma2.

In this context, acoustical mass of a channel is defined as Ma=ρ_air·1_ch/S_ch where ρ_air is the density of air (or whatever gas is transported), 1_ch is the length of the channel and S_ch the cross section of the channel for which the acoustical mass is determined. It is noted that the mass of the air(gas) inside the channel is m=ρ_air·1_ch·S_ch.

Also, in this context, acoustic impedance is defined as the ratio of sound pressure and volume velocity.

In SI-units, sound pressure is expressed in [Pa], volume velocity in [m³/s], and acoustic impedance thus in [Pa·s/m³].

For simple geometries there are text book equations for the lumped-element parameters.

It is noted that the acoustical resistance of a filter element as well as the acoustical mass are independent of the frequency. The acoustical impedance, however, is impedance frequency dependent (increases with frequency), as its equation comprises the acoustical mass multiplied by the frequency. Thus, as the acoustical impedance (see FIG. 20) is a serial connection of the acoustical resistance and the acoustical mass (multiplied by the frequency), the acoustical impedance is frequency dependent, where the acoustical resistance is dominant at lower frequencies and the acoustical mass at higher frequencies. In layman's terms, the resistance defines the low-frequency impedance, and the mass determines when (in frequency) the mass starts having an influence and thus increases the impedance.

In FIG. 20, a high mass, low resistance curve (dashed) is illustrated together with a low mass, high resistance curve (dash-dotted) and the resulting curve (parallel filters) as a dotted curve.

It is seen that the parallel connection of these filters gives a low impedance at lower frequencies (defined primarily by the dashed curve) and a higher impedance at higher frequencies (defined primarily by the dash-dotted curve). This filter is useful for damping a sensitivity peak above the intersection point between the dashed and dashed-dotted line—and preferably well above this frequency.

In general terms, the resistance of the low resistance, high mass filter element is desired as low as possible. The lower the resistance, the less noise is added at the lower frequencies.

The intersection of the two curves is defined by the resistance of the low mass high resistance filter element and the mass of the high mass filter element. This intersection preferably is selected at a frequency below the peak frequency to be dampened. In some situations, it is desired that the intersection point is above a frequency corresponding to 25%, such as above 35%, such as above 50% of the sensitivity peak frequency, such as above 60% of the peak frequency, such as above 70% of the peak frequency.

In general, it is preferred that Ra2 is 90% or less of Ra1, such as 80% or less, such as 70% or less, such as 60% or less, such as 50% or less, such as 40%, such as 30% or less, such as 20% or less, such as 10% or less.

In general, it is preferred that Ma1 is 90% or less of Ma2, such as 80% or less, such as 70% or less, such as 60% or less, such as 50% or less, such as 40%, such as 30% or less, such as 20% or less, such as 10% or less.

As an example (see FIG. 20), if a peak frequency in the 10-20 kHz interval is desired damped, it may be desired to have the curves of “low M, high R” and “high M, low R” intersect between 1 kHz and 10 kHz (in FIG. 20 they intersect at approx. 3.8 kHz).

Then, it may be selected that for frequencies below 1 kHz, the “high M, low R” should be significantly below the curve for “low M, high R”. For example, Ra2<50% of Ra1 (in FIG. 20: Ra2=27% of Ra1) may be selected.

From this, we may select (2*pi*1000*Ma2)<Ra1 (in FIG. 20: 2*pi*1000*Ma2=26% of Ra1).

Additionally: the mass of the first filter element (low mass high resistance) prefereably is small enough (such as to not contribute too much) up to 10 kHz, so, fx, (2*pi*10000*Ma2)<Ra1 (in FIG. 20: 2*pi*10000*Ma2=22% of Ra1).

Thus, it may be desired to firstly determine how large Ra1 should be in order to dampen the resonance peak to the required level, and then use the 3 relations above in order to obtain the other parameters of the two filter elements.

In order to arrive at an element with a large acoustic mass, and a low acoustic resistance, a channel may be provided with a relative large cross sectional area without narrow passages, and with a relatively large length.

To achieve a large acoustical resistance with low acoustic mass, on the other hand, one may design a relatively short channel, with a large cross sectional area, but with a very narrow passage. A common way to do so is by using a fine grid, which can be considered as a large number of very narrow passages in parallel.

Naturally, any number of filter elements may be provided. The presently preferred embodiment is to simply have two filters, but three, four, five, six, eight or even more may be used if desired.

The filter elements open into the chamber. The chamber may be closed so that no sound can enter or escape the chamber apart from via the filter elements. A vent may be provided, however, if desired.

The chamber may have any shape and size. As will be described below, the chamber may be formed by—or comprise—a standard front chamber of a standard sensor. Alternatively, the filter may be provided in a front chamber of a—apart from the filter—standard sensor, whereby the chamber is formed by only a part of the front chamber. Further alternatively, a channel may be provided between the filter and a front chamber of a standard sensor, whereby the chamber is defined partly by the front chamber.

The operation of the chamber may be seen as combining the output of the two filter elements before launching the combined acoustical signals on the movable element.

The second and fourth openings receive the acoustical signals to be filtered by the filter elements. These openings may open directly to the surroundings of the sensor or surroundings of an element or product, such as a hearing aid or hearable, wherein the sensor is embodied. Alternatively, sound from an acoustical signal and/or the surroundings may be guided to the second and fourth openings via a common channel or volume into which the second and fourth openings open, so that the second and fourth openings receive at least substantially the same acoustical signal.

It may be preferred to not have a too large phase difference between the acoustical signals entering the second and fourth openings. Thus, it may be desired that a distance between the second and fourth openings is no more than 20%, such as no more than 10%, such as no more than 5%, such as no more than 2%, such as no more than 1%, such as no more than 0.1% of a wavelength of an acoustical signal desired sensed by the sensor. For sound, for example, an acoustical signal of up to 20 kHz may be desired sensed, whereby a distance between the second and fourth inputs may be desired to be no more than 5 mm, such as no more than 2 mm, such as no more than 1 mm, such as no more than 0.5 mm, such as no more than 0.2 mm. This distance may be an average, a maximum or a minimum distance between the openings.

In this context, the distance preferably is that sound will take from one opening to the other, such as the shortest path outside of the assembly or parts thereof.

In one embodiment, the first filter element comprises one or more first channels each with a first length. Then, a combined cross section of the first channel(s) divided by the first length preferably is above a predetermined threshold.

In one embodiment, the first filter element comprises one or more of a grid, a woven, a non-woven and a porous material. Each of such structures defines a large number of more or less parallel (the general direction of the acoustical signal from input side to output side, even though, in a woven/nonwoven material, the channels will be more tortuous) channels through the filter—channels which have a rather small cross section.

A simple type of first filter element is a grid comprising a number of openings forming the first channels, the grid having a thickness defining the first length. A grid is simpler to calculate and define, even though the other types of filter element are equally useful. A preferred grid has regular channels there through, such as channels with a cross section with a smallest side length of <0.15 mm, such as <0.1 m, such as <0.05 mm, such as <0.025 mm. any number of channels may be used, such as 10-100000, such as 100-10000 or the like.

In one embodiment, the first filter element has a thickness (such as in a general direction of sound travel there through) of 0.01-1 mm, such as 0.02-0.5 mm, such as 0.03-0.3 mm. In many applications, a thickness below 0.015 mm is desired.

The second opening may be an opening into a channel guiding the acoustical signal to the actual filtering element (grid or the like). Alternatively, the opening may itself form the openings into the channels of the actual filter element. Thus, the first opening of the first filter element may have a number of sound openings, where a ratio between open and closed surface is <80%, such as <60%, <40%, <30%, <20% or <10%. Naturally, what is of interest is the number and dimensions of the channels and not the distance between the channels, but for practical reasons, the walls between channels preferably have certain dimensions, and the channels are often desired quite narrow. This drives the ratio between open and closed surface down.

In the situation where the second (or first) opening itself defines the openings into the channels of the first filter element, the first/second opening (combined open and closed surface) preferably has an area of >0.025 mm², such as >0.05 mm², such as >0.08 mm².

In one embodiment, the second filter element comprises one or more second channels each with a second length. In many situations, a single channel suffices. Naturally, multiple channels may also be provided with different dimensions so as to form individual filter elements with different filtering parameters.

In a preferred embodiment, at least one of the second channels has a length of at least 0.25 mm, such as 0.5 mm or more, such as 1 mm or more.

At least one of the second channels may have a cross sectional area of at least 0.025 mm², such as at least 0.05 mm², such as at least 0.08 mm².

Then, a combined cross section of the second channel(s) divided by the second length preferably is below 50% of the above, predetermined threshold. In this manner, the filtering characteristics of the first and second filter elements differ.

In a preferred embodiment, the filter comprises a flat element having two opposing, at least substantially parallel sides, the second filter element having the third opening in one of the two opposing sides and the fourth opening in the other of the two opposing sides and a channel extending in a plane of the parallel sides.

Also, the first opening could be to one of the sides and the second opening to the other.

Then, an acoustical signal may be transported from one side of the filter to the other side by the first and second filter elements acting in parallel, so that gas may pass from the one side to the other through the filter elements to be filtered in the two parallel filters and be re-combined on the other side of the filter. The filter may be configured to only allow sound/acoustical signals or even gas from the first side to the second side via the filter elements.

Thus, a flat, plate-shaped filter may be provided still comprising the two filter elements.

Naturally, the channel may be elongate, straight or bent/curled. Providing the channel inside the filter allows the channel to be longer than the thickness of the filter while allowing the second filter element to have the desired length.

In an interesting embodiment, the sensor further comprises a sensor housing, in which the movable element is positioned, and a filter housing positioned outside of the sensor housing, wherein:
the sensor housing has a sound input,
the filter housing has a sound input and a sound output, the sound output positioned so that sound may be output from the sound output and enter the sensor housing sound input,
the first and second filter elements are positioned in the filter housing, and
the filter housing has elements guiding sound entering the sound input through the first and second filter elements and toward the sound output.

Thus, here the sensor may be a standard sensor with a housing, a sound input and a movable element, such as a diaphragm, therein.

The filter housing has a sound input and a sound output (or input/output for any acoustical signal) and is positioned so that an acoustical signal output of the output can enter the input of the filter housing. In one example, the two housings may abut, or a sound guide, such as a sealing element, may be provided between the sensor housing input and the output.

The filter housing may be of the above shape with two opposing, parallel sides. The first and third openings may form the output of the filter housing, or a common channel may provided, into which the first and third openings open, which channel has an opening forming the filter housing output. The same is the situation for the second and fourth openings and the input.

Naturally, the input and output of the filter housing may be provided on opposite sides of the filter housing. In that manner, the filter may be interposed between a standard sensor and e.g. a housing or the like through which the acoustical signal is received. The filter may now be an intermediate element performing the desired filtering before launching the filtered signal into the sensor.

For example in the situation where the sensor originally was to be attached to a surface of an element, where real estate is reserved for the sensor, the filter may be interposed when, fx:
the sensor housing sound output is provided in a first side of the sensor housing, the first side having, when projected on to a first predetermined plane, a first contour and the sensor housing output a second contour therein,
the filter housing sound output is provided in a first side of the filter housing, the first side having, when projected on to a second predetermined plane, a third contour and the filter housing output a fourth contour therein,
the third contour being provided within the first contour while the second and fourth contours having at least an overlap.

In this situation, the planes may be parallel and parallel to the side of the sensor and/or an element, typically a PCB or a housing portion, to which the sensor was to be fastened to.

In that situation, the filter takes up the same or less space, while the inputs/outputs are situated so that an acoustical signal may enter the filter in the same manner as it was intended to enter the sensor—and exit the sensor and enter the sensor.

Alternatively, the sound output may be provided on one side of the filter housing having also a side opposite thereto and one or more additional sides, the sound input being positioned in one of the one or more additional sides. In that situation, sound may enter the filter from another side, whereby an alternative input direction is obtained while not re-designing the sensor.

Naturally, the sensor may be able to detect movement of the movable element. In one situation:
the sensor further comprises a signal generator connected to the movable element,
the sensor housing has one or more first electrical conductors configured to receive an output of the signal generator, and
the filter housing has one or more second electrical conductors positioned on one side thereof configured to contact the first electrical conductors and, on a side opposite to the one side, one or more third electrical conductors operationally connected to the second electrical conductors.

Thus, often, the conductors of the sensor are provided on the side also having the sound input, so that when the sensor is attached to an element through which the sound is received, an electrical connection may also be obtained to that element. Thus, the filter may have electrical connections facilitating this signal transport even though the filter is interposed.

In this connection, the operational connection may be a direct connection simply transferring the signal across the filter element. Alternatively, the filter may comprise a processor or signal adaptor which receives a signal from the first electrical conductors and outputs another signal to the second conductors. This other signal may be processed, such as noise reduced, amplified, encoded, decoded, filtered, or the like. Thus, in addition to the acoustical filtering, the present filter may also perform an electrical adaptation of the output of the sensor/filter assembly.

In order for the filter to be interposable between a sensor and e.g. a PCB originally designed for a sensor (sound input/output position and position of the electrical conductors), preferably:
the one or more first electrical conductors are provided in or on the first side of the sensor housing, at least one of the first electrical conductors defining in the projection, a fifth contour,
the one or more third electrical conductors are provided in or on the first side of the filter housing, at least one of the third electrical conductors defining, in the projection, a sixth contour,
the third contour being provided within the first contour while the second and fourth contours having at least an overlap and while the fifth and sixth contours overlap.

In one embodiment, the movable element is electrically conducting and the first filter element comprises an electrically conducting, air penetrable element positioned in the housing and at least substantially parallel to a plane of the movable element.

In one situation, a sensor of this type may be an electret type sensor where the movement of the diaphragm is sensed as a potential difference between a back plate and the diaphragm. In this case, the back plate is a conducting element positioned close to the diaphragm (distance of no more than 1 mm, such as no more than 500 μm, such as no more than 250 μm) and is air penetrable to allow the sound to impinge on the diaphragm.

One of the diaphragm and backplate (multilple backplates may be used if desired) may be biased using e.g. a voltage or a constant charge.

A usual structure of a back plate is that of a grid or plate with air ducts. This backplate structure may be used as e.g. the first filter element. In that situation, the second filter element may be formed as a channel extending through the first filter element. This channel may be formed by a tube extending e.g. across a plane of the back plate or extending in the plane thereof in the same manner as the above channel inside the filter.

Alternatively, the second filter element may be defined as a channel extending around the first filter element, such as in a wall of the sensor, where the wall extends from one side of the backplate to the other.

Thus, the filter may be built-in in a sensor using some of the elements or functionalities already present therein.

In relation to the above, interposable filter, which may comprise the filter, so that a standard sensor may be used, it is noted that this filter may be provided in a manner so that it does not itself completely define the filter elements but does so when combined with the sensor. Thus, in one embodiment, the sensor further comprises a sensor housing, in which the movable element is positioned, and a filter housing positioned outside of the sensor housing, wherein:
the sensor housing has a sound input at a predetermined side thereof,
the filter housing has a side portion configured to engage a portion of the predetermined side of the sensor housing, (for example, the side portion may a define cavity for receiving at least a part of the sensor housing) and
the sensor housing and filter housing form, when engaging, the first and/or second filter elements and/or the chamber.

This engagement may be an abutting or even a fixing of one to the other.

In one situation, for example, the second filter element may be an open channel (in the shape of e.g. a ridge) in the filter, which channel is closed by the sensor housing (still having the two openings).

The filter housing may have a cavity wherein the sensor is at least partly received. In one situation, the filter housing is a face plate of a hearable or hearing aid, where a sound input is provided in the faceplate. When the filter is provided in the face plate, filtered sound may then be provided to the sensor which, again, may be a standard sensor.

In fact, an aspect of the invention relates to a filter of this type which defines a part of one of or both filter elements so that both filter elements are functional only when one side—or perhaps two opposite sides, of the filter is/are closed by (an)other element(s). In this manner, the filtering may be obtained with an even thinner element, as upper and lower sides (facing the sensor and PCB/shell for example) thereof are closed by the sensor and PCB or other element (such as a face plate wherein it is mounted), while keeping the thickness of the filter extremely low.

Another aspect of the invention relates to an assembly of a sensor as described above and a plane element, the sensor comprising a sensor housing, wherein the movable element is positioned, and a filter housing positioned outside of the sensor housing, wherein:
the sensor housing has a sound input at a predetermined surface part thereof,
the filter housing has:
a first surface portion configured to engage a portion of the predetermined surface part of the sensor housing,
a second surface portion configured to engage the plane element,
the sensor housing, the filter housing and the plane element form, when engaging, the first and/or second filter elements and/or the chamber.

It is noted that all aspects of the invention may be combined with each other and that all embodiments and options may be freely interchanged between aspects.

Again, the filter housing is positioned outside of the sensor housing, whereby sound needs to exit the filter housing to enter the sensor housing. The filter and sensor may be provided in yet another housing, such as a hearable housing, if desired.

Naturally, the predetermined surface part may be any portion of the sensor. Sometimes the input is provided on a surface designed for mounting to the plane element, sometimes it is on an opposite side, and at other times, it is in a direction perpendicular to the plane element.

In this context, the plane element may be a PCB or the like to which the sensor may be desired mounted e.g. for receiving signals output by the sensor. Alternatively, the plane element may be a portion of e.g. a housing, such as a hearing aid or hearable shell, which portion has a plane surface (may be a portion of a cavity) to which the sensor may be attached.

As mentioned above, the filter may be provided so as to only partly define the first and/or second filter elements which are only fully defined or functional when the filter is assembled or abutted with the sensor and plane element.

Another aspect of the invention relates to a hearable or hearing aid comprising a sensor as described above. This sensor may comprise a filter therein, or a filter may be provided as part of other elements of the hearable or hearing aid.

Another aspect of the invention relates to a hearable comprising a sensor, a filter and a hearable housing, wherein:
the sensor comprises:
a movable element,
a chamber defined at least partially by a first side of the movable element, the filter comprises a first and a second filter element, where:
the first filter element has a first acoustical path with a first and a second opening, an acoustical resistance Ra1, and an acoustical mass Ma1,
the second filter element has a second acoustical path with a third and a fourth opening, an acoustical resistance Ra2, and an acoustical mass Ma2,
the first and third openings open into the chamber,
Ra2<Ra1 and Ma1<Ma2.

Thus, the sensor may be a standard sensor, such as a standard microphone. Alternatively, the filter may be built-in in the sensor as exemplified above. Further alternatively, the filter may be an element separate from the sensor and/or the hearable housing.

Alternatively, the hearable housing comprises the filter, such as if the filter or parts thereof are built-in in the hearable housing in the same manner as described above.

In one situation:
the sensor comprises a sensor housing wherein the movable element is positioned, the sensor housing having a sound input at a predetermined side thereof,
the hearable housing has a side portion configured to engage a portion of the predetermined side of the sensor housing, (again, a side portion may define a cavity for receiving at least a part of the sensor housing), and
the sensor housing and hearable housing form, when engaging, the first and/or second filter elements and/or the chamber.

Thus, as mentioned above, the filter may be completed by the sensor housing, such as an outer wall portion thereof, closing e.g. a channel of a filter element to render the filter element operational.

Naturally, the hearable may also comprise a plane element, such as a PCB, wherein:
the sensor housing has a sound input at a predetermined surface part thereof,
the hearable housing has:
a first surface portion configured to engage a portion of the predetermined surface part of the sensor housing,
a second surface portion configured to engage the plane element,
the sensor housing, the hearable housing and the plane element form, when engaging, the first and/or second filter elements and/or the chamber.

Thus, as described above, the hearable housing may define a portion of the filter elements which are rendered functional only when completed by the plane element and the sensor housing.

Another aspect of the invention relates to a filter, such as a filter for use in the above sensors, filters or hearables, which filter comprises a filter housing, a sound input and a sound output as well as two filter elements as described above, where:
the first and second filter elements are positioned in the filter housing and are each configured to guide sound from the input to the output, and
the filter housing has elements guiding sound entering the sound input through the first and second filter elements and toward the sound output.

The guiding elements may be elements preventing acoustical signals, or even gas, from passing from the input to the output outside of the first and second filter elements.

This filter may have the inputs and outputs, as is described above, on opposite sides, on the same side thereof, or one may be provided on one side, where the other is not provided on that side or an opposite side.

Again, the housing need not fully enclose the filter elements, so that the housing is only closed and the filter elements only operational when one or two sides of the filter are closed by e.g. a sensor housing or other surface.

Naturally, also the above electrical conductors and processor or processing may also be provided, so that the filter may be positioned between a sensor and a PCB also when electrical connections there between is desired.

As mentioned above, it is preferred that:
the first side has, when projected on to a first predetermined plane, a first contour and the sensor housing input a second contour therein,
the second side has, when projected on to the plane, a third contour and the filter housing output a fourth contour therein,
the third contour being provided within the first contour while the second and fourth contours having at least an overlap.

In that manner, the filter may be positioned where the sensor was originally designed to be positioned, so as to bring about the filtering without requiring re-design of the sensor or plane element.

Another aspect of the invention relates to a method of filtering an acoustical signal, the method comprising providing a sensor as described above and feeding the acoustical signal into the first and second parallel paths via the second and fourth openings and to the movable element. In this manner, the acoustical signal impinging on the movable element is filtered by the parallel filters and thus has different characteristics.

Naturally, the filter and sensor may be embodied in any of the manners described above. Thus, the acoustical signal fed to the parallel paths may be fed first through a common signal path, such as a tube. Alternatively or additionally, the acoustical signal output of the parallel paths may be fed into a common signal path before being launched on to the movable element, if desired.

The output of the parallel paths may be fed through an input into a front chamber of a microphone, or the acoustical signal may be fed through the parallel paths while being in the front chamber, if desired, where the filter is present in the front chamber.

Another aspect of the invention relates to a method of sensing an acoustical signal, the method comprising launching the acoustical through two parallel acoustical filter elements to form two filtered acoustical signals, where:
a first of the filter elements has a first acoustical path with a first and a second opening, an acoustical resistance Ra1, and an acoustical mass Ma1,
a second of the filter elements has a second acoustical path with a third and a fourth opening, an acoustical resistance Ra2, and an acoustical mass Ma2, Ra2<Ra1 and Ma1<Ma2,
combining the two filtered acoustical signals and launching them on to a movable element of a sensor.

Again, the filter and sensor may be embodied as mentioned above, and any common acoustic paths may be used before and/or after filtering if desired.

### BRIEF DESCRIPTION OF THE DRAWINGS

In the following, preferred embodiments are described with reference to the drawings, wherein:

FIG. 1 illustrates an embodiment with separate filter and sensor,

FIG. 2 illustrates embodiments of the filter elements,

FIG. 3 illustrates different shapes of tubes,

FIG. 4 illustrates a grid and tube integrated,

FIG. 5 illustrates a stackable embodiment,

FIG. 6 illustrates a sensor with built-in filter,

FIG. 7 illustrates the sensitivity curve of microphones,

FIG. 8 illustrates the noise curve of microphones,

FIG. 9 illustrates a lumped element model of the two filter elements,

FIG. 10 illustrates the peak damping for legacy grids and the invention,

FIG. 11 illustrates the EIN difference between a standard grid and the invention,

FIG. 12 illustrates one embodiment of a sensor with built-in filter,

FIG. 13 illustrates another embodiment of a sensor with built-in filter,

FIG. 14 illustrates another embodiment of a sensor with built-in filter,

FIG. 15 illustrates one embodiment of a sensor with a separate filter,

FIG. 16 illustrates another embodiment of a sensor with a separate filter,

FIG. 17 illustrates another embodiment of a sensor with separate filter,

FIG. 18 illustrates one embodiment of a sensor in a shell with a built-in filter,

FIG. 19 illustrates another embodiment of a sensor in a shell with a built-in filter,

FIG. 20 illustrates the acoustical impedance of a filter according to the invention and

FIG. 21 illustrates a dual sensor set-up.

### DETAILED DESCRIPTION OF THE INVENTION

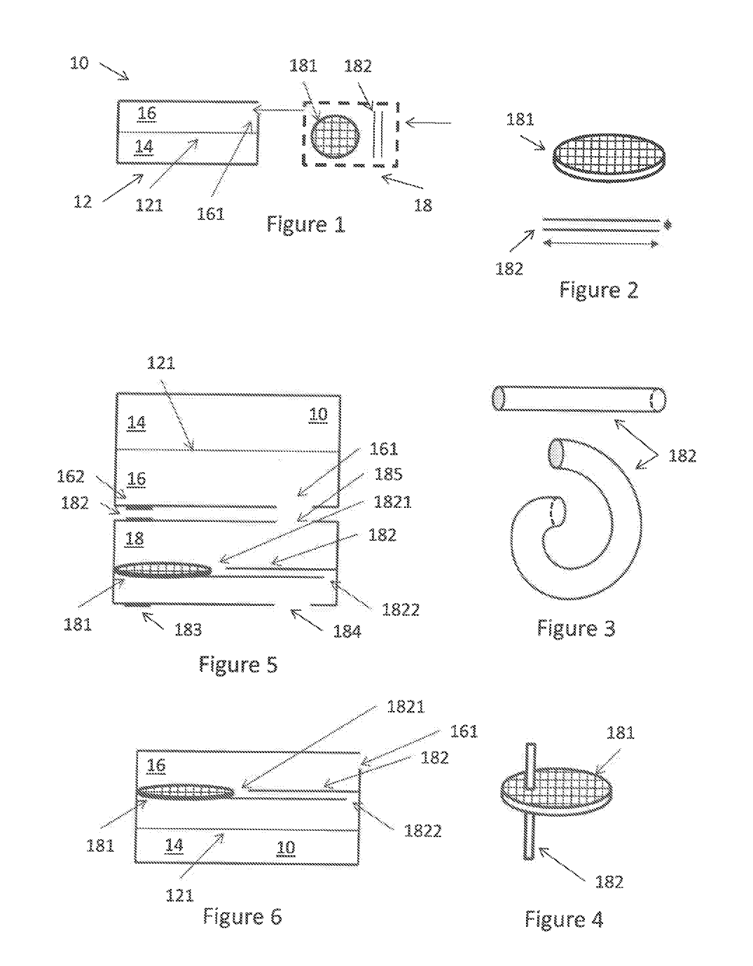

In FIG. 1, a sensor 10 is illustrated having a standard sensor, such as a MEMS microphone, a vibration sensor, or the like, having a housing, a diaphragm 121 dividing the inner space of the housing into two chambers 14 and 16 as well as a sound input 161. A filter 18 is illustrated having two parallel filtering paths or elements 181 and 182. Sound entering the filter will pass the filter through the two parallel paths/elements and thus be acoustically filtered. The filtered sound is fed into the sound input 161.

A typical problem in sensors 12 is that a sensitivity of sensors often has a peak which provides difficulties. Limiting the peak has, as is described above, been attempted in different manners, such as by filtering the incoming sound in a grid, but such manners often tend in the addition of excessive noise.

The invention relates to filtering, using a particular type of filter, sound before it reaches the diaphragm.

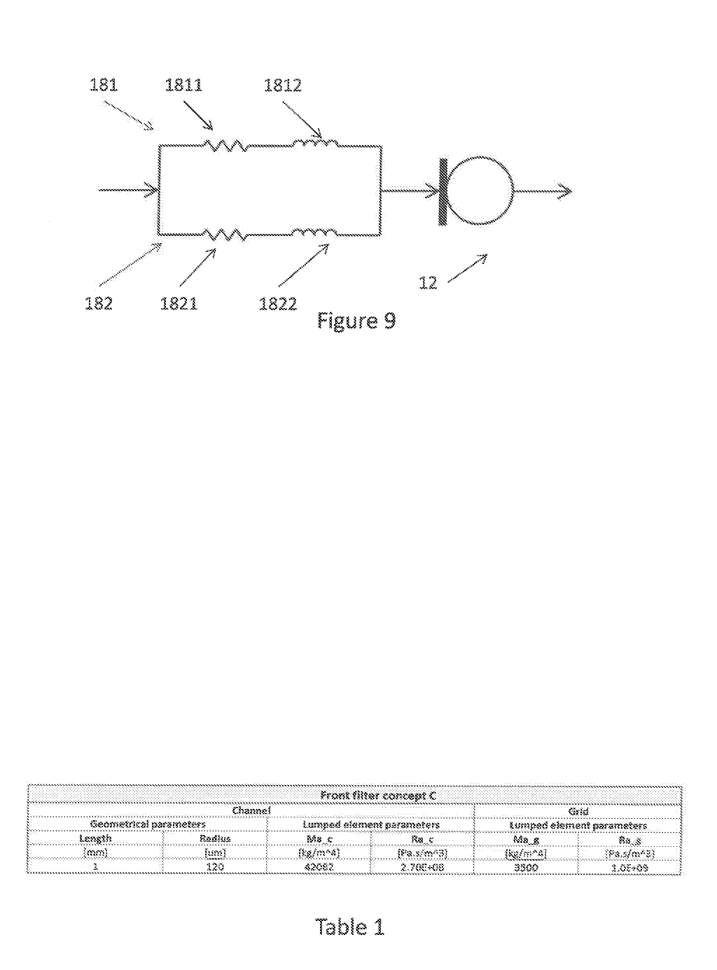

A basic lumped element model is shown in FIG. 9. The filter comprises two parallel paths, 181 and 182, one, 181, with high mass 1812, and low resistance 1811 (may be implemented as a channel), and one, 182, with low mass 1822 and high resistance 1821 (may be implemented as a grid). The mass and resistance values of each path will create a cross-over frequency below which all flow will go through the high mass—low resistance channel 182 (no damping and no noise added) and above which all flow will go to the high resistance—low mass channel 181 (added damping and noise).

Thus, by selecting the mass and resistance values, it is possible to dampen the peak as much as what a grid would do, and to reduce the noise increase in the mid frequency range (e.g. at 1 kHz) significantly compared to an standard acoustically damped microphone. This thus leads to a significant SNR increase while allowing comparable peak damping as known state of the art solutions. Moreover, because this damping option is fully acoustical, no distortion is added.

Practically speaking, 4 parameters are determined:
Ra_channel: resistance of the “acoustical channel” (preferably is low).
Ma_channel: Mass of the “acoustical channel” (preferably is high).
Ra_grid: Resistance of the “acoustical grid” (preferably is high).
Ma_grid: Mass of the “acoustical grid” (preferably is low).

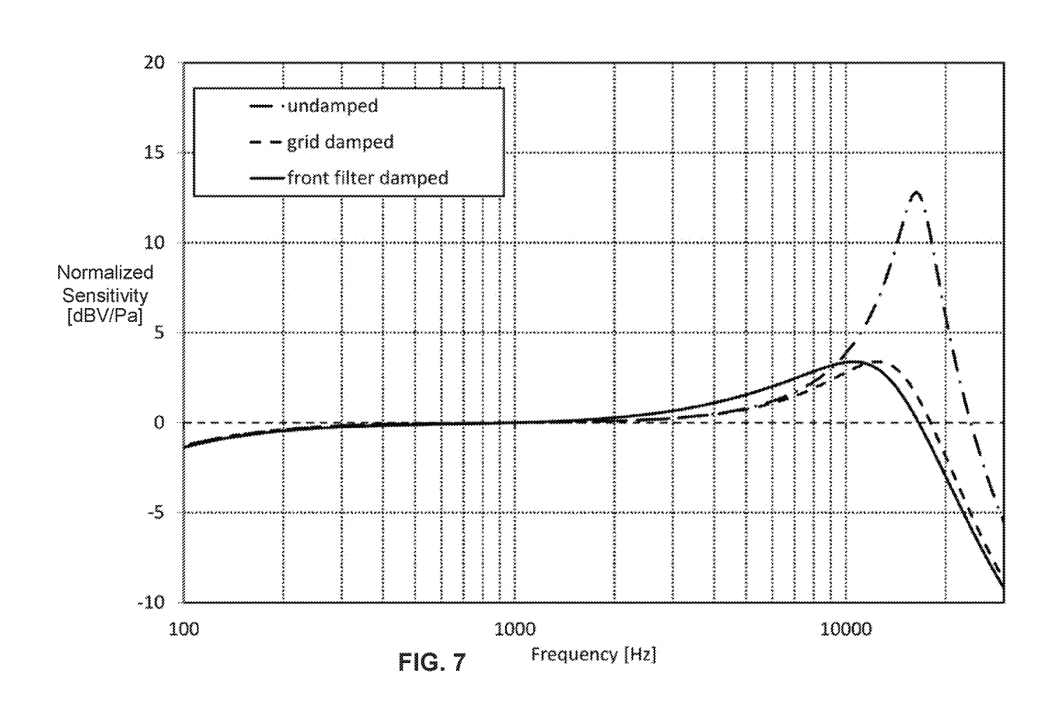

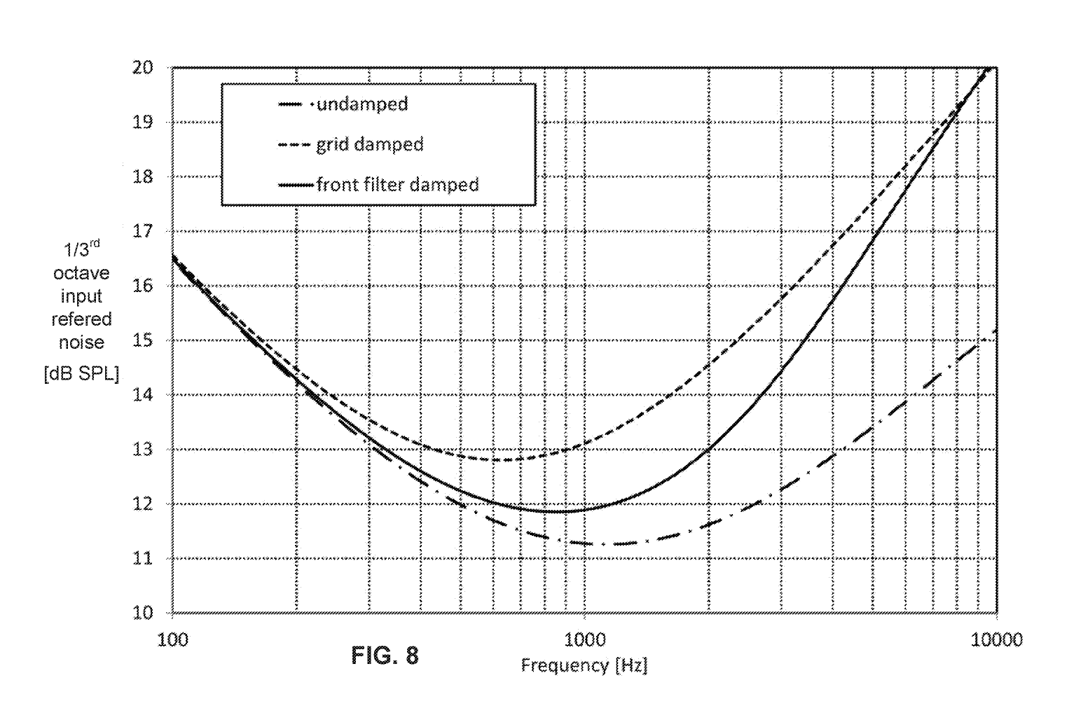

FIGS. 7 and 8 illustrate the sensitivity and noise curves (normalized frequency response and EIN graphs) of the following concepts:
Standard undamped Sonion O11AC03 microphone.
Sonion O11AC03 microphones using a “standard” damping grid (Ra_grid) of 7e8 Pa·s/m̂3 (and Ma_grid=3500 kg/m̂4).
Sonion O11AC03 microphone with a filter according to the invention and with the geometrical and acoustical values described in Table 1.

TABLE 1
Front filter concept C

| Channel | | | | Grid | |
|---|---|---|---|---|---|
| Geometrical | | Lumped | | Lumped | |
| parameters | | element parameters | | element parameters | |
| Length | Radius | Ma_c | Ra_c | Ma_g | Ra_g |
| [mm] | [um] | [kg/m⁴] | [Pa · s/m³] | [kg/m⁴] | [Pa · s/m³] |
| 1 | 120 | 42082 | 2.70E+08 | 3500 | 1.05 + 09 |

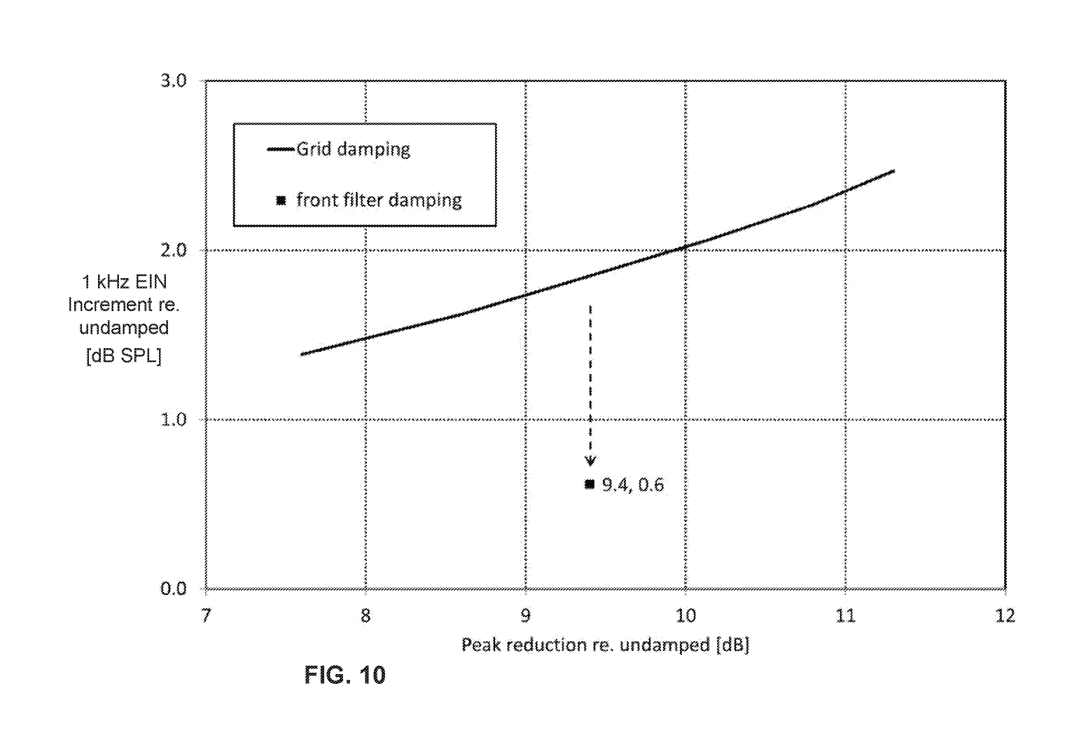

FIG. 10 shows the added values of the presented concept: the solid line describes the peak damping for grids with increasing resistance (going from left to right: 5e8 Pa·s/m̂3 to 1e9 Pa·s/m̂3) for similar peak damping than a grid with 7e8 Pa·s/m̂3 (9.4 dB damping), the filter according to the invention adds only 0.6 dB of noise instead of the 1.8 dB noise increase for the standard grid. The efficiency of the filter of table 2 is 15.2 dB damping per dB of noise increase at 1 kHz while the efficiency of a 7e8 Pa·s/m̂3 standard grid is 5.1 dB damping per dB of noise increase.

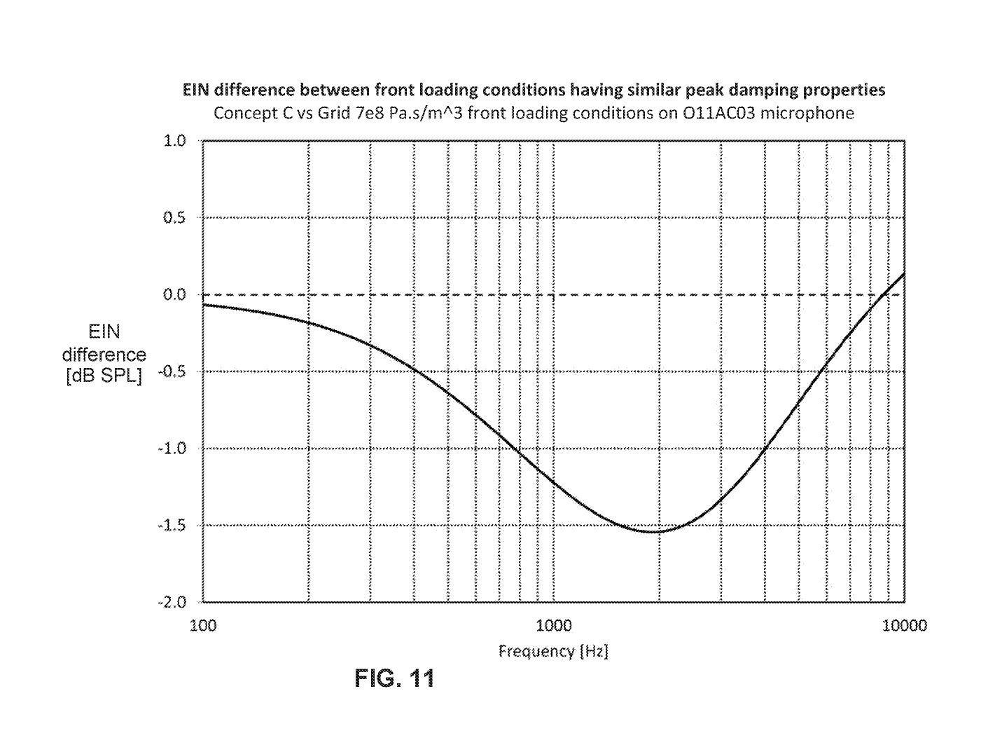

FIG. 11 represents the overall EIN increase difference between the filter of table 1 and a standard 7e8 Pa·s/m̂3 grid compared to a standard O11AC03 microphone. It can be seen that the SNR improvement compared to standard acoustical damping is even better around 2 to 3 kHz, which is usually the most critical frequency bands for microphones in order to comply with the Nordic (−3 dB) standard.

Reverting to a more generic description of the filter, clearly, it has to (or more) parallel paths each filter a part of the incoming sound, where the two paths or filter elements are different.

One filter element may be constituted by a high resistance and a low mass, such as grating and the other by a lower resistance, higher mass, such as a tube or channel. Naturally, the tube may be replaced by multiple tubes or other elements having a suitably low mass and a suitably high resistance.

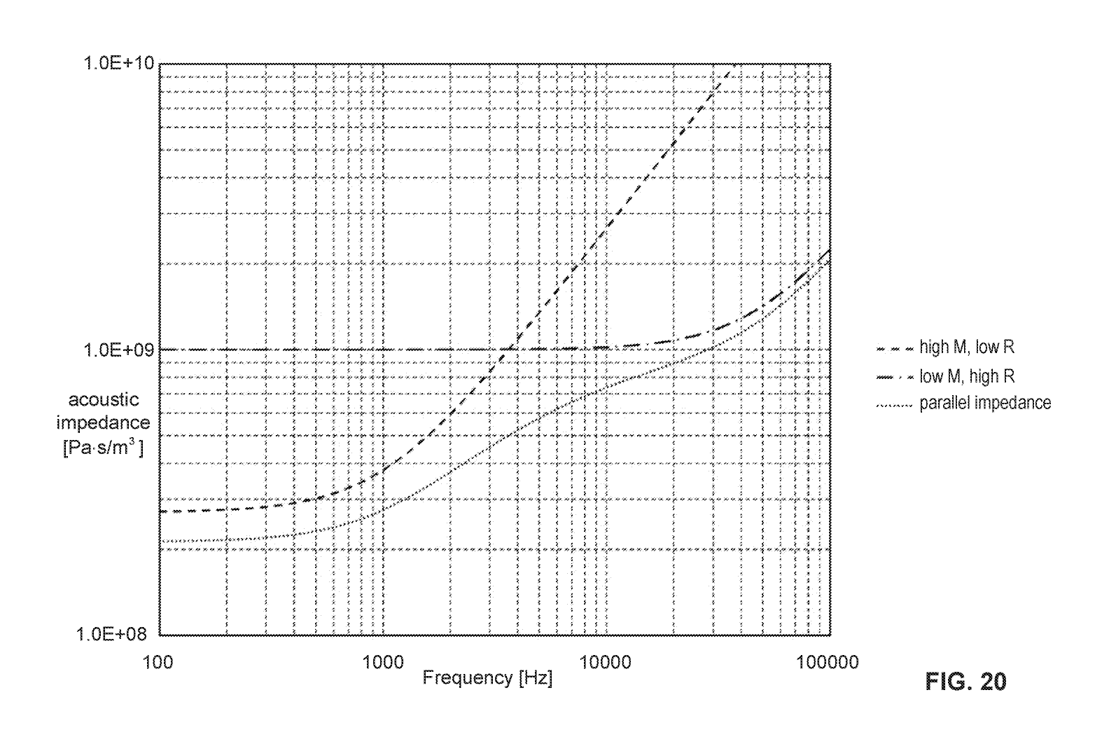

FIG. 20 illustrates the acoustic impedance of a low mass, high resistance filter element, a high mass, low resistance filter element and a parallel connection of such two filter elements.

In this context, acoustic impedance is defined as the ratio of sound pressure and volume velocity.

In SI-units, sound pressure is expressed in [Pa], volume velocity in [m³/s], and acoustic impedance thus in [Pa·s/m³].

For simple geometries there are text book equations for the lumped-element parameters.

For example, for a channel we find for the acoustic mass [kg/m⁴]:

Mₐ=ρₐᵢᵣ·l_{ch}/S_{ch}

Where ρₐᵢᵣ is the mass density of air in [kg/m³], l_{ch} the length of the channel [m] en S_{ch} the cross sectional area of the channel [m²], independently of the shape of the cross section.

In contrast, acoustic resistances are dependent of the shape of the cross section. For a circular cross section we find in [Pa·s/m³]:

Rₐ=8ηₐᵢᵣ·l_{tube}(π·r_{tube})

Where ηₐᵢᵣ is the dynamic viscosity of air in [Pa·s] and r_{tube} the inner radius of the tube.

For a rectangular cross section we find in [Pa·s/m³]:

Rₐ=12ηₐᵢᵣ·lₛₗ/(wₛₗ·hₛₗ³)

where wₛₗ is the width of the slit in [m] and hₛₗ is the height in [m] (wₛₗ>hₛₗ).

The complex acoustic impedance equals:

Zₐ=Rₐ+j·2πf·Mₐ

where j is the complex unit, and f is the sound frequency. The magnitude of the impedance is:

|Zₐ|=\sqrt{Rₐ²+(2πf·Mₐ)²}

In order to arrive at an element with a large acoustic mass, and a low acoustic resistance, a channel may be provided with a relative large cross sectional area without narrow passages, and with a relatively large length.

To achieve a large acoustical resistance with low acoustic mass, on the other hand, one may design a relatively short channel, with a large cross sectional area, but with a very narrow passage. A common way to do so is by using a fine grid, which can be considered as a large number of very narrow passages in parallel.

With given values for the acoustical impedance, the required dimensions may be obtained for the two channels.

The calculations may be simplified if a rectangular cross-section is selected (see FIG. 2):

For the channel with large acoustic mass, and low acoustic resistance, a minimum side length is given by:

hₛₗ>Mₐ/Rₐ·12 ηₐᵢᵣ/ρₐᵢᵣ

For the channel with large acoustical resistance with low acoustic mass, the maximum side length is given by:

hₛₗ<Mₐ/Rₐ·12ηₐᵢᵣ/ρₐᵢᵣ

Consequently, the ratio of length and width can be derived.

l_{ch}/wₛₗ=Mₐ·hₛₗ/ρₐᵢᵣ

For example, for an element with Rₐ<0.27·10⁹ Pa·s/m³ and Mₐ=42000 kg/m⁴, hₛₗ>0.17 mm. Choosing a height hₛₗ=0.2 mm, and length l_{ch}=1 mm, we find wₛₗ>0.3 mm.

As another example, for the element with Rₐ=1·10⁹ Pa·s/m³ and Mₐ<3500 kg/m⁴, hₛₗ<26 μm. Choosing a height hₛₗ=25 μm, and a length corresponding to the thickness of the grid of l_{ch}=75 μm, we find wₛₗ>1 mm. This large width may be divided into multiple sections, e.g. 40 times 25 μm, so that a grid with 40 holes of 25×25 μm can be used to implement this filter element.

For the grid, a large variety of materials and structures may be used all defining a number of narrow channels from one portion to the other. A grid is a simple type which is also simple to use, when it is desired to calculate and/or control the acoustical resistance and mass. Other types of materials are porous materials, woven materials and non-wovens.

Especially for hearables and hearing aid uses and/or uses with standard microphones, the following dimensions are preferred for grids:
thickness <0.15 mm, such as 0.1 mm, 0.075 mm, 0.05 mm
height/width of holes in grid (whichever is smallest)<0.15 mm, such as 0.1 mm, 0.05 mm 0.025 mm
ratio of open surface/closed surface area <80%, such as 60%, 40%, 20%, 10%,
total surface area >0.025 mm̂2, such as 0.05 mm̂2, 0.08 mm̂2
   Naturally, the grid/woven/non-woven/porous may be made of any solid or stable material, such as metals, alloys, polymers, plastics or the like.

Naturally, any cross sections of the tube(s) and the grid openings may be selected, such as circular or rectangular. The same principles apply. Also, a tube may be straight or angled/curved/bent, and it may have its openings at the same side of an element wherein the tube or channel is defined (such as a plane element with two major, opposed sides). In FIG. 3, a channel is illustrated having one opening (gray with solid lines) facing out of the paper and an opening (white with hatched lines) facing downwardly into the paper. For hearing aid or hearable use, a length of 0.2-5 mm may be suitable, such as between 0.25 and 1 mm, and a cross sectional area of 0.01-1 mm², such as 0.025-0.1 mm².

The filtered sound is filtered by two (or more) parallel filter elements. In FIG. 1, they are illustrated side by side. Another embodiment is illustrated in FIG. 4 illustrating the combining of a grid and a tube.

Having now understood the underlying technology, this filter type may be used in a number of different contexts. Naturally, as seen in FIGS. 1 and 5, the filter may be positioned outside of the actual sensor 12, which may then be a standard off-the-shelf sensor. Alternatively, the filter may be provided inside the sensor, as is seen in FIGS. 6, 12, 13, and 14. Actually, the filter elements may also be obtained partly by a filter and partly by the sensor, as is seen in FIGS. 15-19.

In FIG. 5, the filter 18 has a separate housing with a sound input 184, a sound output 185 and two filtering elements 181 and 182, where 181 is a grating and 182 is a tube. Sound entering the sound inlet 184 must pass one of the filtering elements 181/182 in order to reach the sound output 185. Thus, an element is provided which spans the width of the filter housing. This element comprises the grid 182 and openings 1821 and 1822 into the channel 182, so that the channel 182 extends within this element but opens to both sides thereof. The channel preferably mainly extends within a plane of this element. This channel may be straight or bent/curved.

Thus, where, usually, the sensor 10 would simply receive the sound from any source through its input 161, perhaps through a legacy grid, an intermediate filter may now be used, which filters the sound before launching the sound into the sensor 10. The sensor thus may be of any known type.

Often, sensors are to be attached to an element, such as a PCB, so as to transfer electrical signals from the sensor to the PCB and onwards to other elements such as processors/amplifiers. Also, power or voltages may be fed to the sensor in order for it to operate.

In this situation, the filter 18 may have conductors 182, for connection to the usual conductors 162 of the sensor 10, and conductors 181 for connection to the other element, such as the PCB.

Naturally, the positions of the conductors and the sound inputs/outputs may be chosen so that the filter may be attached to a PCB in the same position as that of the sensor without the filter. The same real estate may be used—or the filter may actually be made to have a smaller cross section to free surface space on the PCB.

Thus, the filter 18 may simply be interposed between the sensor and the PCB to filter the sound before launching it into the sensor.

Naturally, the conductors (any number of conductors may be provided) may simply be connected to each other to transfer signals and/or voltage between the PCB and the sensor. Alternatively, signal processing, voltage conversion or the like may be performed by electronics or circuits provided in the filter to provide additional functionality to the sensor when combined with the filter.

In FIG. 6, the filter is positioned in the front chamber 16 of the sensor and between the sound input 161 and the diaphragm 121. The filter element of FIG. 5 may be used in the sense that the same element spanning now the front chamber if used so that the sound may impinge on the diaphragm only via either the grid 181 or the channel 182.

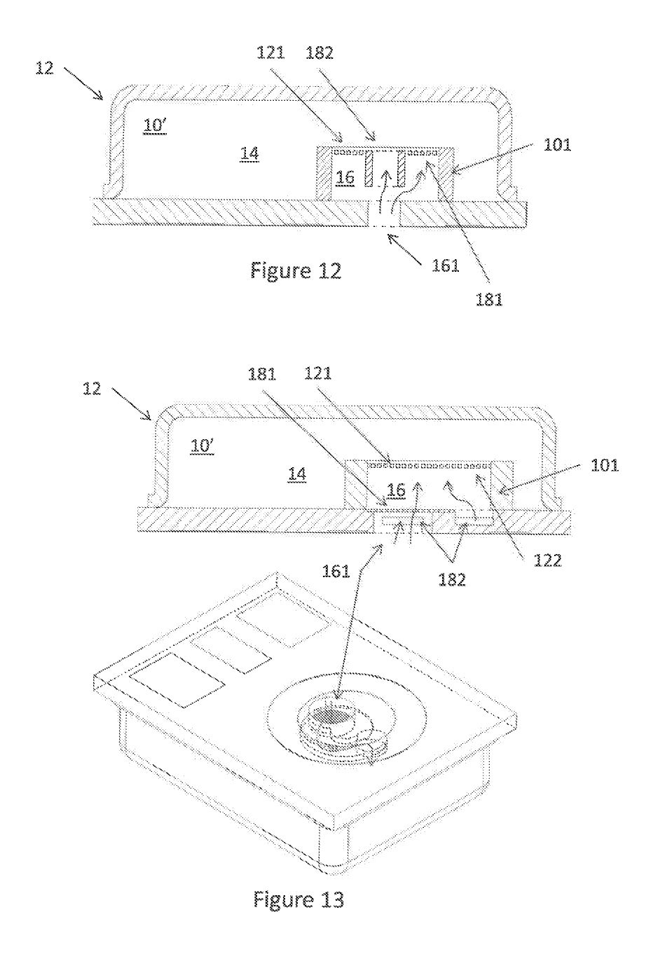

In FIG. 12, another embodiment is seen wherein the filter elements are built into a sensor, which in this embodiment may be MEMS sensor. This sensor 10′ has a housing 12 comprising an upper housing portion and a lower, plane portion in which a sound input 161 is provided.

As is usual in MEMS sensors, the diaphragm 121 is fastened to a tubular element 101 defining the front chamber 16. Parallel to the diaphragm 121 is provided a back plate. A movement of the diaphragm 121 may be determined from a variation in potential between the back plate and the diaphragm. Often, one of the diaphragm and the back plate is biased either by a voltage or by a fixed charge being provided thereto.

The backplate is sound transmissive in order to allow sound to reach the diaphragm. Often, this is obtained by providing a back plate with openings.

In this embodiment, the back plate forms the function also of the filter element 181. Thus, the back plate parameters are selected according to the desired filtering of the high resistance low mass filter element.

The other filter element 182, low resistance, high mass, is provided as a tube extending through the back plate much in the same manner as in FIG. 4. Alternatively, this filter element may be provided in the wall 101 with an opening below the grid 181 and between the grid 181 and the diaphragm 121.

Two curved arrows illustrate the sound passing through the two filter elements.

In FIG. 13, a MEMS type sensor is illustrated with a usual diaphragm 121 back plate 122 structure and where the filter elements 181 and 182 are built-in in the flat base element. In the sound opening 161, the filter element 181 is provided, here in the form of a grid. The filter element 182 is provided as a channel from inside of the sound inlet 161, inside the base element, in a plane thereof and around the portion holding the grid 181, and to an opening into the front chamber 16, effectively guiding sound into the front chamber 16 around the filter element 181. In FIG. 13, an elevated side view is presented where the curved channel 182 is seen in hatched lines and with a curved arrow.

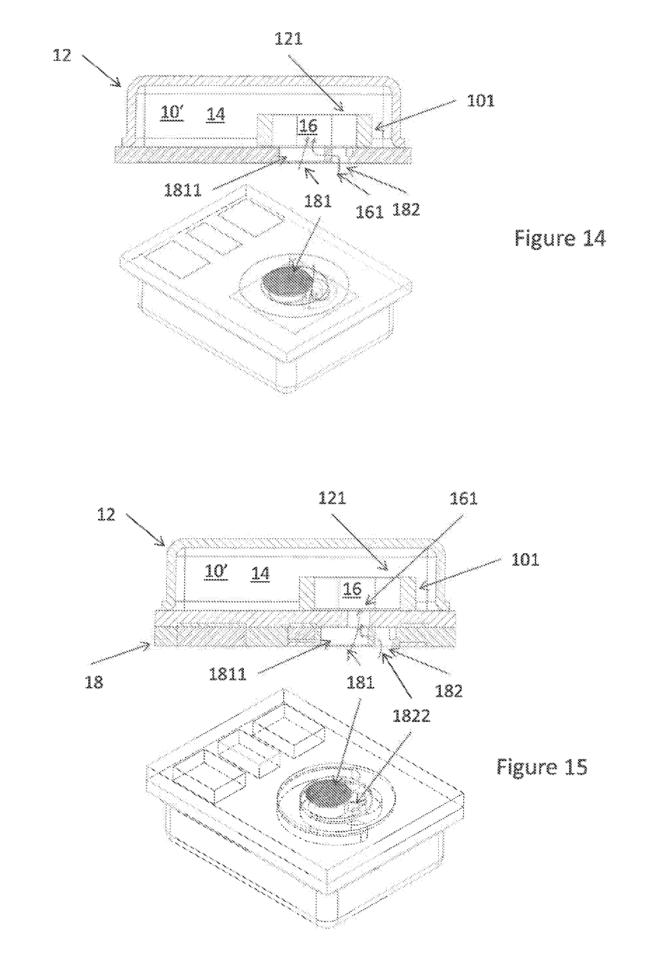

In FIG. 14, a MEMS type sensor is illustrated similar to that of FIG. 13, but where the sound inlet 161 now is formed by two openings, one opening having a grid 181 and above this the front chamber 16 and another opening into a channel forming the filter element 182. This channel again is provided inside the base element and now around the channel above the grid 181 and to an opening into the front chamber 16 next to the grid 181. Again, an elevated side view is presented wherein the channel 182 is seen in hatched lines and a curved arrow.

In FIG. 15, a standard MEMS sensor 12 is illustrated having a sound inlet 161, a diaphragm 121 and front and back chambers 16/14.

However, a filter embodied in the same manner as in FIG. 14 is provided—but now in a separate, plane element 18 (see the above description relating to FIGS. 5 and 6). Thus, one filter element 181 is provided as a grid and a large (non-filtering) channel guiding the thus filtered sound to the sound inlet 161. The other filter element 182 is provided as a channel inside the element 18 with an inlet opening to the surroundings next to the grid and an outlet opening into the channel above the grid to emit sound toward the inlet 161.

Thus, the element 18 of FIG. 15 may be as that of FIG. 5, thus also including conductors, processors and the like. It is seen that the addition of the thin element 18 increases the functionality of the sensor 12 without adding more than a bit to the height thereof. The sensor and the filter may be provided in the same manner as the sensor 12 originally, as the sound inlet of the filter is in the same position as that of the sensor 12. Preferably, the inlets to the two filters 181/182 are both within the circumference of the inlet of the sensor 12, so that the filter may receive sound into both filter elements from an opening with that size and shape.

Again, an elevated side view is presented where the grid 181 and the opening 1822 are seen and the channel 182 is seen in hatched lines.

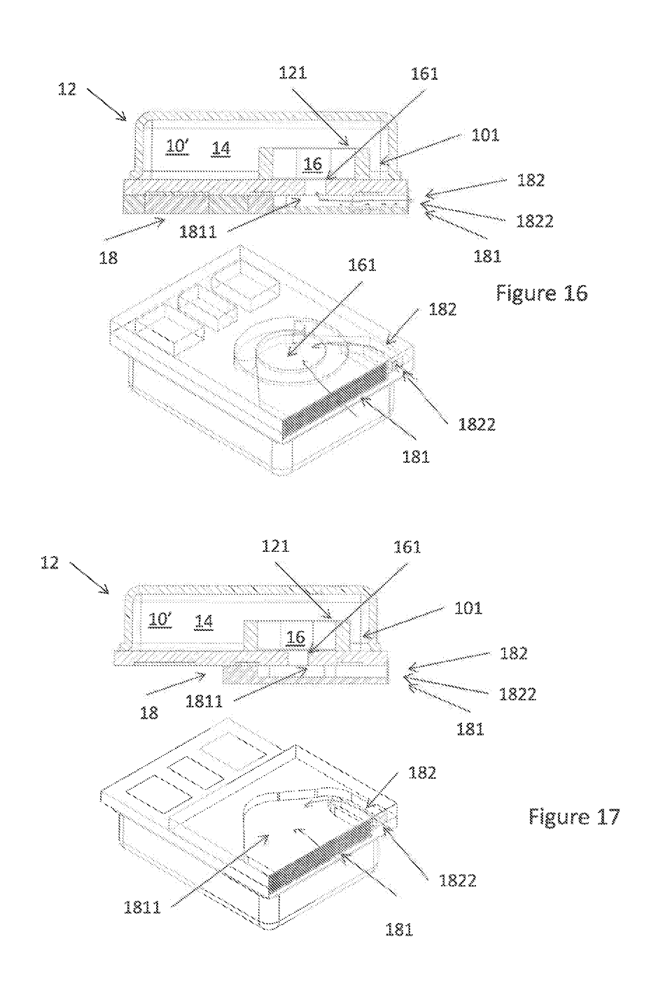

In FIG. 16, a sensor 12 is seen as that in FIG. 15. Also, a separate filter 18 is seen on which the sensor 12 is mounted. Again, the filter 18 delivers filtered sound to the sound inlet 161. However, in this embodiment, the sound inlet to the filter 18 is from the side.

Again, the filter 181 is embodied as a grid which is provided between the surroundings and a channel guiding filtered sound to the sound inlet 161. The other filter element 182 is embodied as a channel having an opening 1822 to the surroundings and next to the grid 181 and an opening 1821 opening into the channel and/or the sound inlet 161.

Naturally, the above additional functionality of the filter 18 may also be provided in this embodiment.

Again, an elevated side view is seen illustrating the grid, the opening 1822 and the channel 182 in hatched lines.

In FIG. 17, a filter 18 of the type seen in FIG. 16 is illustrated together with a standard sensor which, again, may be of any desired type.

In FIG. 17, however, it is illustrated that the filter 18 may, in fact, be made with a cross-sectional area even smaller than that of the sensor 12, so that real estate may be freed on e.g. a PCB to which the filter 18 is to be fastened to also fix the sensor 12 to the PCB. Now, the sensor may be fixed directly to an underlying PCT, for example, or an element may be provided between the PCB and sensor for e.g. adapting the output of the sensor before feeding to the PCB.

Thus, as the filter 18 of FIG. 17 may be made purely mechanical without electrical conductors, the filter 18 may be made of a wide selection of materials, such as plastics, and the production techniques may be selected freely.

In relation to FIGS. 15-17, it is seen that the filter elements therein and/or the channels formed in the filter 18 may, in fact, be at least partly defined by an outer surface of the sensor 12 and/or a PCB or other element to which the filter is to be attached. Thus, taken alone, the filter 18 need not form the filter channel 182 but may define an upwardly and/or downwardly open structure which is to be closed by the sensor and/or PCB to actually form the channel, so that the desired filtering takes place.

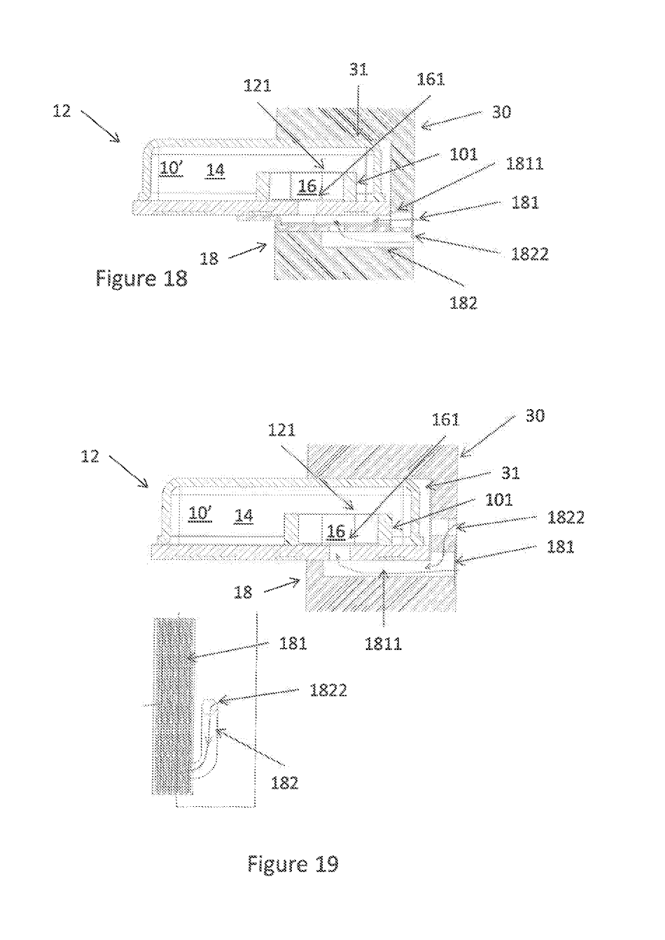

In FIGS. 18 and 19, the sensor 20 is provided in a hearable having an outer shell, such as a so-called face-plate 30. The sensor is provided in, such as fixed inside, a cavity 31 of the face plate, so that the sound inlet 161 is provided inside the face plate.

The filter 181 is embodied as a grid facing the surroundings and filtering sound passing the grid and entering a channel toward the sound inlet 161.

The filter 182 is embodied as a channel with an opening 1822 toward the surroundings and next to the grid and another opening into the channel between the sound inlet and the grid.

The channel and the filter element 182 are formed in the face plate 30. As mentioned above, the channel and filter element 182 need not be defined fully in the face plate 30 but may be at least partly defined by the sensor housing.

In FIG. 19, a side view is provided where the grid 181 and the opening 1822 are seen and where the channel 182 is illustrated in hatched lines.

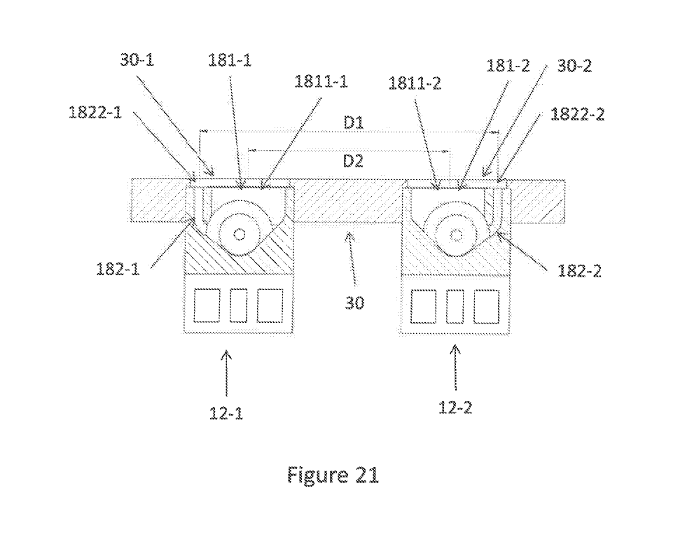

In FIG. 21, a dual-sensor set-up is illustrated having two sensors of the type seen in FIG. 17, which are mirrored. The sensor 12-1 has a channel 182-1 with an opening 1822-1 and a filter grid 181-1 with an opening 1811-1. The sensor 12-2 has a channel 182-2 with an opening 1822-2 and a filter grid 181-2 with an opening 1811-2. The channels 182-1 and 182-2 are, due to the mirroring, positioned farther apart (distance D1) than the grid openings 1811-1 and 1811-2 (distance D2). The sensors are mounted in an element 30, which may be a face plate or the like of a hearing aid or a hearable. Openings 30-1 and 30-2 are provided through which sound may reach the openings 1811-1, 1811-2, 1822-1 and 1822-2.

This set-up may be a matched pair of sensors, which sensors then are matched to output at least substantially the same output (frequency spectrum) and thus be optimal for directional detection or beamforming.

When the distance D1 is larger than D2, the signal-to-noise ratio of the set-up is improved for low frequencies.

Naturally, the relation between D1 and D2 may be selected in any manner. D1 may be 1.1-200 times D2, such as 1.1-100 times D2, such as 1.2-10 times D2 if desired. The distance D2 may be selected as usual in relation to the directivity sensitivity desired as well as the dimensions of the element 30.

### Embodiments

1. A sensor comprising:
a movable element,
a chamber being at least partly defined by the movable element,
a filter comprising a first and a second filter element, where
the first filter element has a first acoustical path with a first and a second opening, an acoustical resistance Ra1, and an acoustical mass Ma1,
the second filter element has a second acoustical path with a third and a fourth opening, an acoustical resistance Ra2, and an acoustical mass Ma2,
the first and third openings open into the chamber,
Ra2<Ra1 and Ma1<Ma2.

2. A sensor according to embodiment 1, wherein the first filter element comprises one or more first channels each with a first length.

3. A sensor according to embodiment 2, wherein a combined cross section of the first channel(s) divided by the first length preferably is above a predetermined threshold.

4. A sensor according to any of the above embodiments, wherein the first filter element comprises a grid comprising a number of openings forming the first channels, the grid having a thickness defining the first length.

5. A sensor according to any of the preceding embodiments, wherein the first filter element comprises one or more of a grid, a woven, a non-woven and a porous material.

6. A sensor according to claim 5, wherein the first filter element has a thickness of 0.01-1 mm, such as 0.02-0.5 mm, such as 0.03-0.3 mm, such as below 0.015 mm.

6.1. A sensor according to claim 5 or 6, wherein the first opening of the first filter element has a number of sound openings, where a ratio between open and closed surface is <80%, such as <60%, <40%, <30%, <20% or <10%.

6.2. A sensor according to any of claims 5, 6 and 6.1, wherein the first opening (open and closed surface) is >0.025 mm², such as >0.05 mm², such as >0.08 mm².

6.3. A sensor according to any of claims 5, 6, 6.1 and 6.2, wherein the first filter element comprises a grid with regular channels there through, where the channels have a cross section with a smallest side length of <0.15 mm, such as <0.1 m, <0.05 mm<0.025 mm.

7. A sensor according to any of the preceding embodiments, wherein the second filter element comprises one or more second channels each with a second length.

8. A sensor according to claim 7, wherein at least one of the second channels has a length of at least 0.25 mm, such as 0.5 mm or more, such as 1 mm or more.

9. A sensor according to claim 7 or 8, wherein at least one of the second channels has a cross sectional area of at least 0.025 mm2, such as at least 0.05 mm2, such as at least 0.08 mm2.

10. A sensor according to embodiment 7 and 3, wherein a combined cross section of the second channel(s) divided by the second length preferably is below 50% of the predetermined threshold.

11. A sensor according to any of embodiments 7-10, wherein the second filter element comprises a tube having a cross section being the second cross section and a length being the second length.

12. A sensor according to any of the preceding embodiments, wherein the filter comprises a flat element having two opposing, at least substantially parallel sides, the second filter element having the third opening in one of the two opposing sides and the fourth opening in the other of the two opposing sides and a channel extending in a plane of the parallel sides.

13. A sensor according to embodiment 12, wherein the channel is elongate, straight or bent/curled.

14. A sensor according to any of the preceding embodiments, further comprising a sensor housing, in which the movable element is positioned, and a filter housing positioned outside of the sensor housing, wherein:
the sensor housing has a sound input,
the filter housing has a sound input and a sound output, the sound output positioned so that sound may be output from the sound output and enter the sensor housing sound input,
the first and second filter elements are positioned in the filter housing, and
the filter housing has elements guiding sound entering the sound input through the first and second filter elements and toward the sound output.

15. A sensor according to embodiment 14, wherein the sound input is provided on one side of the filter housing and the sound output on a second, opposite side of the filter housing.

16. A sensor according to embodiment 15, wherein:
the sensor housing sound input is provided in a first side of the sensor housing, the first side having, when projected on to a first predetermined plane, a first contour and the sensor housing output a second contour therein,
the filter housing sound output is provided in a first side of the filter housing, the first side having, when projected on to a second predetermined plane, a third contour and the filter housing output a fourth contour therein,
the third contour being provided within the first contour while the second and fourth contours having at least an overlap.

17. A sensor according to embodiment 14, wherein the sound output is provided on one side of the filter housing having also a side opposite thereto and one or more additional sides, the sound input being positioned in one of the one or more additional sides.

18. A sensor according to any of embodiments 14-17, wherein:
the sensor further comprises a signal generator connected to the movable element,
the sensor housing has one or more first electrical conductors configured to receive an output of the signal generator, and
the filter housing has one or more second electrical conductors positioned on one side thereof configured to contact the first electrical conductors and, on a side opposite to the one side, one or more third electrical conductors operationally connected to the second electrical conductors.

19. A sensor according to embodiment 18, wherein:
the one or more first electrical conductors are provided in or on the first side of the sensor housing, at least one of the first electrical conductors defining in the projection, a fifth contour,
the one or more third electrical conductors are provided in or on the first side of the filter housing, at least one of the third electrical conductors defining in the projection, a sixth contour,
the third contour being provided within the first contour while the second and fourth contours having at least an overlap and while the fifth and sixth contours overlap.

20. A sensor according to any of the preceding embodiments, wherein the movable element is electrically conducting and the first filter element comprises an electrically conducting, air penetrable element positioned in the housing and at least substantially parallel to a plane of the movable element.

21. A sensor according to embodiment 20, wherein the second filter element defines a channel extending through the first filter element.

22. A sensor according to any of the preceding embodiments, further comprising a sensor housing, in which the movable element is positioned, and a filter housing positioned outside of the sensor housing, wherein:
the sensor housing has a sound input at a predetermined side thereof,
the filter housing has a side portion configured to engage a portion of the predetermined side of the sensor housing,
the sensor housing and filter housing form, when engaging, the first and/or second filter elements in communication with the sensor housing sound input.

23. An assembly of a sensor according to any of the preceding embodiments and a plane element, the sensor comprising a sensor housing, wherein the movable element is positioned, and filter housing positioned outside of the sensor housing, wherein:
the sensor housing has a sound input at a predetermined surface part thereof,
the filter housing has:
a first surface portion configured to engage a portion of the predetermined surface part of the sensor housing,
a second surface portion configured to engage the plane element,
the sensor housing, the filter housing and the plane element form, when engaging, the first and/or second filter elements and/or the second common air volume in communication with the sensor housing sound input.

23′. A hearable comprising a sensor according to any of embodiments 1-22.

24. A hearable comprising a sensor, a filter and a hearable housing, wherein:

the sensor comprises:
a movable element,
a chamber defined at least partially by a first side of the movable element, the filter comprises a first and a second filter element, where
the first filter element has a first acoustical path with a first and a second opening, an acoustical resistance Ra1, and an acoustical mass Ma1,
the second filter element has a second acoustical path with a third and a fourth opening, an acoustical resistance Ra2, and an acoustical mass Ma2,
the first and third openings open into the chamber,
Ra2<Ra1 and Ma1<Ma2.

25. A hearable according to embodiment 24, wherein the hearable housing comprises the filter.

26. A hearable according to embodiment 24 or 25, wherein:
the sensor comprises a sensor housing wherein the movable element is positioned, the sensor housing having a sound input at a predetermined side thereof,
the hearable housing has a side portion configured to engage a portion of the predetermined side of the sensor housing,
the sensor housing and hearable housing form, when engaging, the first and/or second filter elements and/or the chamber.

27. A hearable according to any of embodiments 24-26, further comprising a plane element, wherein:
the sensor housing has a sound input at a predetermined surface part thereof,
the hearable housing has:
a first surface portion configured to engage a portion of the predetermined surface part of the sensor housing,
a second surface portion configured to engage the plane element,
the sensor housing, the hearable housing and the plane element form, when engaging, the first and/or second filter elements and/or the chamber.

28. A filter, such as for use in the sensor according to embodiment 14, the filter comprising a filter housing, a sound input and a sound output and a first and second filter elements,
the first and second filter elements are positioned in the filter housing and are each configured to guide sound from the input to the output, and
the filter housing has elements guiding sound entering the sound input through the first and second filter elements and toward the sound output.

29. A filter according to embodiment 28′, wherein the sound input is provided on one side of the filter housing and the sound output on a second, opposite side of the filter housing.

30. A filter according to embodiment 29, wherein:
the first side has, when projected on to a first predetermined plane, a first contour and the sensor housing input a second contour therein,
the second side has, when projected on to the plane, a third contour and the filter housing output a fourth contour therein,
the third contour being provided within the first contour while the second and fourth contours having at least an overlap.

31. A filter according to embodiment 28, wherein the sound output is provided on one side of the filter housing having also a side opposite thereto and one or more additional sides, the sound input being positioned in one of the one or more additional sides.

32. A method of filtering an acoustical signal, the method comprising providing a sensor according to any of embodiments 1-22 and feeding the acoustical signal into the first and second parallel paths from the second and fourth openings and to the movable element.

33. A method of sensing an acoustical signal, the method comprising launching the acoustical through two parallel acoustical filter elements to form two filtered acoustical signals:
a first of the filter elements has a first acoustical path with a first and a second opening, an acoustical resistance Ra1, and an acoustical mass Ma1,
a second of the filter elements has a second acoustical path with a third and a fourth opening, an acoustical resistance Ra2, and an acoustical mass Ma2, Ra2<Ra1 and Ma1<Ma2,
combining the two filtered acoustical signals and launching them on to a movable element of a sensor.

1. A sensor comprising:
a movable element,
a chamber being at least partly defined by the movable element,
a filter comprising a first and a second filter element, where
the first filter element has a first acoustical path with a first and a second opening, an acoustical resistance Ra1, and an acoustical mass Ma1,
the second filter element has a second acoustical path with a third and a fourth opening, an acoustical resistance Ra2, and an acoustical mass Ma2,
the first and third openings open into the chamber,
the second and fourth openings are provided with a distance between them of no more than 5 mm,
Ra2<Ra1 and Ma1<Ma2.

2. A sensor according to claim 1, wherein the first filter element comprises a grid comprising a number of openings forming the first channels, the grid having a thickness defining the first length.

3. A sensor according to claim 1, wherein the first filter element comprises one or more of a grid, a woven, a non-woven and a porous material.

4. A sensor according to claim 1, wherein the second filter element comprises one or more second channels each with a second length.

5. A sensor according to claim 4, wherein at least one of the second channels has a length of at least 0.25 mm, or 0.5 mm or more, or 1 mm or more and wherein at least one of the second channels has a cross sectional area of at least 0.025 mm², or at least 0.05 mm², or at least 0.08 mm².

6. A sensor according to claim 1, further comprising a sensor housing, in which the movable element is positioned, and a filter housing positioned outside of the sensor housing, wherein:
the sensor housing has a sound input,
the filter housing has a sound input and a sound output, the sound output positioned so that sound may be output from the sound output and enter the sensor housing sound input,
the first and second filter elements are positioned in the filter housing, and
the filter housing has elements guiding sound entering the sound input through the first and second filter elements and toward the sound output.

7. A sensor according to claim 6, wherein:
the sensor further comprises a signal generator connected to the movable element,
the sensor housing has one or more first electrical conductors configured to receive an output of the signal generator, and
the filter housing has one or more second electrical conductors positioned on one side thereof configured to contact the first electrical conductors and, on a side opposite to the one side, one or more third electrical conductors operationally connected to the second electrical conductors.

8. A sensor according to claim 1, wherein the movable element is electrically conducting and the first filter element comprises an electrically conducting, air penetrable element positioned in the housing and at least substantially parallel to a plane of the movable element.

9. A sensor according to claim 8, wherein the second filter element defines a channel extending through the first filter element.

10. A sensor according to claim 1, further comprising a sensor housing, in which the movable element is positioned, and a filter housing positioned outside of the sensor housing, wherein:
the sensor housing has a sound input at a predetermined side thereof,
the filter housing has a side portion configured to engage a portion of the predetermined side of the sensor housing,
the sensor housing and filter housing form, when engaging, the first and/or second filter elements in communication with the sensor housing sound input.

11. An assembly of a sensor according to claim 1 and a plane element, the sensor comprising a sensor housing, wherein the movable element is positioned, and filter housing positioned outside of the sensor housing, wherein:
the sensor housing has a sound input at a predetermined surface part thereof,
the filter housing has:
a first surface portion configured to engage a portion of the predetermined surface part of the sensor housing,
a second surface portion configured to engage the plane element,
the sensor housing, the filter housing and the plane element form, when engaging, the first and/or second filter elements and/or the chamber.

12. A hearable comprising a sensor, a filter and a hearable housing, wherein:
the sensor comprises a movable element having a first side defining at least part of a chamber,
the filter comprises a first and a second filter element, where
the first filter element has a first acoustical path with a first and a second opening, an acoustical resistance Ra1, and an acoustical mass Ma1,
the second filter element has a second acoustical path with a third and a fourth opening, an acoustical resistance Ra2, and an acoustical mass Ma2,
the first and third openings open into the chamber,
Ra2<Ra1 and Ma1<Ma2.

13. A hearable according to claim 12, wherein the hearable housing comprises the filter.

14. (canceled)

15. A method of sensing an acoustical signal, the method comprising launching the acoustical through two parallel acoustical filter elements to form two filtered acoustical signals:
a first of the filter elements has a first acoustical path with a first and a second opening, an acoustical resistance Ra1, and an acoustical mass Ma1,
a second of the filter elements has a second acoustical path with a third and a fourth opening, an acoustical resistance Ra2, and an acoustical mass Ma2, Ra2<Ra1 and Ma1<Ma2,
combining the two filtered acoustical signals and launching them on to a movable element of a sensor.
